(19) United States
(12) Patent Application Publication
(10) Pub. No.: US 2005/0169117 A1
(43) Pub. Date: Aug. 4, 2005

(54) Magneto-optical recording medium and method of manufacturing the same

(75) Inventors: Takahiro Umada, Kawasaki (JP); Mineo Moribe, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/098,324

(22) Filed: Apr. 4, 2005

Related U.S. Application Data
(63) Continuation of application No. PCT/JP03/05599, filed on May 1, 2003.

(30) Foreign Application Priority Data
Dec. 24, 2002 (JP) 2002-371782

(51) Int. Cl. G11B 7/24

(52) U.S. Cl. 369/13.35; 369/13.55

(57) ABSTRACT

The magneto-optical recording medium (X1) includes a resin substrate (S1) having a pre-groove surface (1a) on which pre-grooves (1b) are formed, a recording magnetic section (11) performing a recording function and a reproduction function, a soft magnetic plating layer (12) provided between the resin substrate (S1) and the recording magnetic section (11), and a bonding layer (13) interposed between the resin substrate (S1) and the soft magnetic plating layer (12) for enhancing attachment between the resin substrate (S1) and the soft magnetic plating layer (12).

### TECHNICAL FIELD

The present invention relates to a magneto-optical recording medium having a soft magnetic layer, and a method of manufacturing such a magneto-optical recording medium.

### BACKGROUND ART

Magneto-optical recording mediums have been the subject of much attention in recent years. Magneto-optical recording mediums employ a variety of magnetic properties of magnetic materials, and are rewritable recording mediums having two functions of thermomagnetic recording and reproduction employing magneto-optical effects. Magneto-optical recording mediums have a recording magnetic section comprising one or more perpendicularly magnetized films. Signals are recorded on the recording layer in the recording magnetic section. During recording, the prescribed location on the recording layer is heated by illumination with a laser focused via an objective lens while the prescribed magnetic field is applied at the relevant location. Thus, the prescribed signals are recorded as changes in orientation of magnetization within the recording layer. These recorded signals are read with the prescribed optical system during reproduction.

Reducing the size of the area illuminated by the laser, in other words, reducing the spot diameter, on the medium during recording is known as one method of improving recording density of the magneto-optical recording medium. By reducing the spot diameter, the track pitch of the medium can be designed to be shorter, recording mark length can be reduced, and recording density can be enhanced. The spot diameter can be reduced by reducing the laser wavelength, and by increasing the numerical aperture NA of the objective lens employed in focusing the illuminating laser (i.e., the lens facing the medium).

The focal distance of the lens is reduced as the numerical aperture NA of the lens is increased. In the technical field of magneto-optical recording mediums, in order to employ a lens of large numerical aperture NA, the practical application of a front-illumination method is demanded in place of the conventional back-illumination method.

With back-illuminated magneto-optical recording mediums, the recording magnetic section is illuminated by laser from the transparent substrate side during recording and reproduction. Since this transparent substrate is required to be of considerable thickness to ensure stiffness of the medium, use of a lens having a short focal distance, in other words, a large numerical aperture NA, becomes difficult for a back-illuminated magneto-optical recording medium.

On the other hand, with front-illuminated magneto-optical recording mediums, the recording magnetic section is illuminated by laser from the transparent protective film side provided on the side opposite to the substrate, during recording and reproduction. Since the transparent protective film is formed very thin, a lens of short focal distance, in other words, a lens of large numerical aperture NA, can be employed for front-illuminated magneto-optical recording mediums.

In order to enhance sensitivity in relation to the magnetic field from the recording magnetic head (electromagnet) during recording with front-illuminated magneto-optical recording mediums, use may be made of a soft magnetic layer provided between the substrate and the recording magnetic section. Such magneto-optical recording medium are disclosed in JP-A-H03-105741 and JP-A-H03-137837.

FIG. 15 shows a laminated configuration of a magneto-optical recording medium X4 as an example of a conventional magneto-optical recording medium. The magneto-optical recording medium X4 is a configured as a front-illuminated magneto-optical disk having a laminated structure comprised of a substrate S3, a recording magnetic section 91, a soft magnetic layer 92, a pre-groove layer 93, a heat conduction layer 94, dielectric layers 95 and 96, and a protective film 97.

The recording magnetic section 91 has a magnetic structure capable of supporting the two functions: thermomagnetic recording and reproduction using magneto-optical effects. The section comprises one or more perpendicularly magnetized films, the number of which depends upon the reproduction method. One of the perpendicularly magnetized films is the recording layer. The soft magnetic layer 92 is comprised of a magnetic film of high magnetic permeability, has an axis of easy magnetization in a direction parallel to the surface of the magnetic film (“longitudinal direction”), and is a magnetized film within the surface. The pre-groove layer 93 is made of a synthetic resin material and has a contact surface with the heat conduction layer 94, the contact surface being uneven for forming land grooves. The heat conduction layer 94 efficiently conducts heat generated in the recording magnetic section 91 to the substrate side. The dielectric layers 95 and 96 ensure that the recording magnetic section 91 is not subject to physical and chemical effects from the exterior. The protective film 97 particularly protects the recording magnetic section 91 from dust, and is made of an optically transparent synthetic resin material.

The conventional magneto-optical recording medium X4 is manufactured by first forming the soft magnetic layer 92 by forming a film of soft magnetic material on the substrate S3 with the sputtering method. Next, the pre-groove layer 93 made of synthetic resin material is formed on the soft magnetic layer 92 using a technique commonly known as the 2P method. Next, the heat conduction layer 94, the dielectric layer 95, the recording magnetic section 91, and the dielectric layer 96 are formed in that order on the pre-groove layer 93 by forming films of each prescribed material using the sputtering method. A film of UV cure resin is then formed on the dielectric layer 96 using the spin coating method, and the synthetic resin is UV-cured to form the protective film 97.

In the magneto-optical recording medium X4, the soft magnetic layer 92 of high magnetic permeability exists. Thus, during recording, the magnetic flux of the magnetic field applied to the recording magnetic section 91 from the magnetic recording head tends not to be dispersed but to be concentrated. Therefore, the recording magnetic field sensitivity of the recording layer included in the recording magnetic section 91 is enhanced in comparison to the case in which the soft magnetic layer 92 does not exist.

With the conventional magneto-optical recording medium X4, a glass or aluminum substrate S3 is employed. Since glass and aluminum substrate are comparatively expensive, implementation of a comparatively inexpensive resin substrate is desirable. However, when the substrate S3 is made of synthetic resin, the soft magnetic layer 92 often fails to be formed properly on the substrate S3 by the sputtering method, as opposed to the conventional case in which the sputtering is appropriate for forming the soft magnetic layer 92.

When forming the soft magnetic layer 92 using the sputtering method, the substrate S3 must be heated to a comparatively high temperature to form the film of soft magnetic material. In making the substrate S3 of synthetic resin material, after a film of soft magnetic material is formed, the substrate S3 and the soft magnetic layer 92 are cooled and contract. However, since the difference in the thermal expansion coefficients of the synthetic resin material and the soft magnetic material is large, the soft magnetic layer 92, which contracts to a smaller degree than the substrate S3, is subject to undesirable stress. Thus, when the soft magnetic layer 92 is formed on the resin substrate S3 by sputtering, cracking and peeling can readily occur in the soft magnetic layer 92.

In terms of achieving satisfactory throughput in industrial production of the conventional magneto-optical recording medium X4, use of an electroless deposition method in place of the sputtering method is desirable for formation of the soft magnetic layer 92 of a considerable thickness. However, when a resin substrate is employed as the substrate S3, and the film of soft magnetic material is formed directly on the resin substrate with the electroless deposition method, the resultant soft magnetic plating layer and the resin substrate are not attached to each other sufficiently to withstand practical use of the magneto-optical recording medium.

### DISCLOSURE OF THE INVENTION

The present invention has been proposed under the circumstances described above. It is therefore an object of the present invention to provide a front-illuminated magneto-optical recording medium having reliable attachment between the plated soft magnetic layer and the resin substrate, and another object is to provide a method of manufacturing such a magneto-optical recording medium.

A magneto-optical recording medium is provided according to the first aspect of the present invention. The magneto-optical recording medium comprises a resin substrate having a pre-groove surface on which pre-grooves are formed, a recording magnetic section performing a recording function and a reproduction function, a soft magnetic plating layer provided between a resin substrate and a recording magnetic section, and a bonding layer to increase attachment between the resin substrate and soft magnetic plating layer, the bonding layer being interposed between the resin substrate and the soft magnetic plating layer. This magneto-optical recording medium includes a soft magnetic layer between the resin substrate and the recording magnetic section. The front-illumination method, wherein the recording magnetic section is illuminated by a laser from the side opposite to the substrate, is employed for recording and reproducing data with the magneto-optical recording medium.

In manufacture of magneto-optical recording mediums having such a configuration, the bonding layer is formed on the resin substrate, and the soft magnetic plating layer is then formed on the bonding layer with a plating method. The bonding layer provides superior attachment with the substrate of the synthetic resin material, and superior attachment with the plated film of soft magnetic material. For example, AlCr, Al, Cr, Ti, FeCo, Ni, NiP, Pd, SiN, and SiO₂ may be employed as this material. Since the bonding layer is interposed between the soft magnetic plating layer and the resin substrate, it is possible to obtain satisfactory attachment between the soft magnetic plating layer and the resin substrate in the magneto-optical recording medium.

In the magneto-optical recording medium according to the first aspect of the present invention, the resin substrate itself functions as the pre-groove layer for formation of the land groove shape in the recording magnetic section. Thus, there is no need to separately provide a pre-groove layer between the soft magnetic plating layer and the recording magnetic section. The soft magnetic plating layer and the recording magnetic section are so adjacent to each other that the function of the soft magnetic plating layer of improving the magnetic field sensitivity of the recording layer within the recording magnetic section can be realized efficiently.

In the magneto-optical recording medium according to the first aspect of the present invention, a comparatively inexpensive resin substrate is employed in place of the conventional glass substrate and aluminum substrate. The present magneto-optical recording medium is therefore ideal for reducing manufacturing costs.

In the magneto-optical recording medium according to the first aspect of the present invention, the soft magnetic layer employed to enhance the recording magnetic field sensitivity of the recording layer is formed by an electroless deposition method, which is capable of realizing satisfactory throughput, in place of the sputtering method employed in the manufacture of conventional mediums. The present magneto-optical recording medium is therefore ideal for enhancing manufacturing efficiency.

A further magneto-optical recording medium is provided according to the second aspect of the present invention. This magneto-optical recording medium comprises a resin substrate, a recording magnetic section performing a recording function and a reproduction function, a soft magnetic plating layer provided between the resin substrate and the recording magnetic section, a pre-groove layer provided between the soft magnetic plating layer and the recording magnetic section, and a bonding layer to increase attachment between the resin substrate and soft magnetic plating layer, the bonding layer being interposed between the resin substrate and the soft magnetic plating layer. The magneto-optical recording medium has a soft magnetic layer between the resin substrate and the recording magnetic section. The front-illumination method, wherein the recording magnetic section is illuminated by a laser from the side opposite to the substrate, is employed for recording and reproducing data with the magneto-optical recording medium.

In manufacturing a magneto-optical recording medium having such a configuration, a bonding layer is formed on the resin substrate, and a soft magnetic plating layer is then laminated on the bonding layer with a plating method. The bonding layer provides superior attachment with the substrate made of synthetic resin material, and superior attachment with the plated film made of soft magnetic material. In the present magneto-optical recording medium, as with the magneto-optical recording medium according to the first aspect of the magneto-optical recording medium, it is possible to obtain satisfactory attachment between the soft magnetic plating layer and the resin substrate.

In the magneto-optical recording medium according to the second aspect of the present invention, the pre-groove layer and the recording magnetic section are adjacent to each other, wherein the pre-groove layer is directly imprinted with the uneven shape of the stamper for forming the pre-grooves. Such a configuration is ideal for realizing the land groove shape with high dimensional accuracy in the recording magnetic section.

Since a comparatively inexpensive resin substrate is employed in the magneto-optical recording medium according to the second aspect of the present invention, the magneto-optical recording medium is ideal for reducing manufacturing costs. Furthermore, in the present magneto-optical recording medium, since the soft magnetic layer employed to enhance the recording magnetic field sensitivity of the recording layer can be formed by an electroless deposition method which is capable of realizing satisfactory throughput, the magneto-optical recording medium is ideal for enhancing manufacturing efficiency.

In the first and second aspects of the present invention, it is desirable that the bonding layer comprise a material selected from the group of AlCr, Al, Cr, Ti, FeCo, Ni, NiP, Pd, SiN, and SiO₂. Such a configuration is ideal for obtaining a plated layer having superior attachment with the resin substrate and with the soft magnetic plating layer.

Preferably, a bonding layer may have a thickness of between 5 nm and 30 nm. The function of the bonding layer in improving attachment between the soft magnetic plating layer and the resin substrate tends to be manifested at thicknesses of 5 nm and greater. On the other hand, when forming the bonding layer using the sputtering method, for example, there is a tendency to be unable to form the resin substrate appropriately at thicknesses in excess of 30 nm.

Preferably, the soft magnetic plating layer may be of CoNiFe. CoNiFe is an amorphous soft magnetic alloy, and is ideal for enhancing the recording magnetic field sensitivity of the recording layer in the magneto-optical recording medium.

In the second aspect of the present invention, preferably, the pre-groove layer may be made of a synthetic resin material, and the magneto-optical recording medium may be provided with a bonding layer to enhance attachment of the soft magnetic plating layer and pre-groove layer. When the pre-groove layer is made of synthetic resin material, and the pre-groove layer is provided directly on the soft magnetic plating layer, sufficient attachment between the two layers may not be obtained in some cases. The above configuration is ideal for avoiding this problem.

A method of manufacturing a magneto-optical recording medium is provided according to the third aspect of the present invention. The method includes the process of forming a bonding layer on the pre-groove surface of a resin substrate, the surface being formed with pre-grooves by forming a film of a material selected from the group of AlCr, Al, Cr, Ti, FeCo, Ni, NiP, Pd, SiN, and SiO₂ with a sputtering method. The process of forming a soft magnetic plating layer on the bonding layer is performed by forming a film of soft magnetic material using an electroless deposition method, and the process of forming a recording magnetic section having a recording function and a reproduction function is performed. The recording magnetic section may be formed after the heat sink and dielectric layers are formed.

According to such a method, the magneto-optical recording medium according to the first aspect of the present invention can be appropriately manufactured. According to the third aspect of the present invention, the advantages described above in relation to the first aspect can be demonstrated in the manufactured magneto-optical recording medium. Furthermore, according to the third aspect, since the electroless deposition method is employed as a method of forming a soft magnetic plating layer included in the recording magnetic section, satisfactory throughput can be realized.

A method of manufacturing a magneto-optical recording medium is provided according to the fourth aspect of the present invention. The method includes: the process of forming a bonding layer on a resin substrate by forming a film of a material selected from the group of AlCr, Al, Cr, Ti, FeCo, Ni, NiP, Pd, SiN, and SiO₂ with a sputtering method; the process of forming a soft magnetic plating layer on the bonding layer by forming a film of soft magnetic material using an electroless deposition method; the process of forming a pre-groove layer on the soft magnetic plating layer; and the process of forming a recording magnetic section performing a recording function and a reproduction function. The pre-groove layer has a pre-groove surface opposite to the substrate, the surface being formed with pre-grooves. The recording magnetic section may be formed after the heat sink and dielectric layers and the like are formed on the pre-groove layer.

According to such a method, the magneto-optical recording medium according to the second aspect of the present invention can be appropriately manufactured. According to the fourth aspect of the present invention, the advantages described above in relation to the second aspect can be demonstrated in the manufactured magneto-optical recording medium. Furthermore, according to the fourth aspect, since the electroless deposition method is employed as a method of forming the soft magnetic plating layer included in the recording magnetic section, satisfactory throughput can be realized in formation of the soft magnetic layer.

A further method of manufacturing a magneto-optical recording medium is provided according to the fifth aspect of the present invention. The method includes: the process of forming a first bonding layer on a resin substrate by forming a film of a material selected from the group of AlCr, Al, Cr, Ti, FeCo, Ni, NiP, Pd, SiN, and SiO₂ with a sputtering method; the process of forming a soft magnetic plating layer on the bonding layer by forming a film of soft magnetic material using the electroless deposition method; the process of forming a second bonding layer on the soft magnetic plating layer by forming a film of a material selected from the group of AlCr, Al, Cr, Ti, FeCo, Ni, NiP, Pd, SiN, and SiO₂ with a sputtering method; the process of forming a pre-groove layer made of synthetic resin material on the second bonding layer; and the process of forming a recording magnetic section performing a recording function and a reproduction function. The pre-groove layer has a pre-groove surface opposite to the substrate, the pre-groove surface being formed with pre-grooves. The recording magnetic section is formed after the heat sink and dielectric layers are formed on the pre-groove layer.

According to such a method, the magneto-optical recording medium according to the second aspect of the present invention can be appropriately manufactured. According to the fifth aspect of the present invention, therefore, the advantages described above in relation to the second aspect can be demonstrated in the manufactured magneto-optical recording medium. Furthermore, according to the fifth aspect, since the electroless deposition method is employed as a method of forming the soft magnetic plating layer included in the recording magnetic section, satisfactory throughput can be realized in formation of the soft magnetic layer.

In the third through fifth aspects of the present invention, preferably, a bonding layer may have a thickness of between 5 nm and 30 nm. Preferably, the soft magnetic plating layer may be formed of a film of CoNiFe.

### BRIEF DESCRIPTION OF THE DRAWINGS

FIG. 1 is a partial cross-sectional view showing the magneto-optical recording medium according to the first embodiment of the present invention;

FIG. 2 shows the laminated configuration of the data tracks in the magneto-optical recording medium shown in FIG. 1;

FIG. 3A through FIG. 3C show some of the processes in the method of manufacturing the magneto-optical recording medium shown in FIG. 1;

FIG. 4A and FIG. 4B show the processes following FIG. 3C;

FIG. 5 is a partial cross-sectional view showing the magneto-optical recording medium according to the second embodiment of the present invention;

FIG. 6 shows the laminated configuration of the data tracks in the magneto-optical recording medium shown in FIG. 5;

FIG. 7A through FIG. 7C show some of the processes in the method of manufacturing the magneto-optical recording medium shown in FIG. 6;

FIG. 8A through FIG. 8C show the processes following FIG. 7C;

FIG. 9A and FIG. 9B show the processes following FIG. 8C;

FIG. 10 is a partial cross-sectional view showing the magneto-optical recording medium according to the third embodiment of the present invention;

FIG. 11 shows the laminated configuration of the data tracks in the magneto-optical recording medium shown in FIG. 10;

FIG. 12 shows the laminated configuration of the data tracks in the magneto-optical recording medium of Example 1;

FIG. 13 shows the laminated configuration of the data tracks in the magneto-optical recording medium of Example 2;

FIG. 14 shows the dependence of the bit error rate on the recording magnetic field for groove tracks and land tracks in the magneto-optical recording medium of Example 1; and

FIG. 15 shows the laminated configuration of the conventional magneto-optical recording medium having a soft magnetic layer.

### BEST MODE FOR CARRYING OUT THE INVENTION

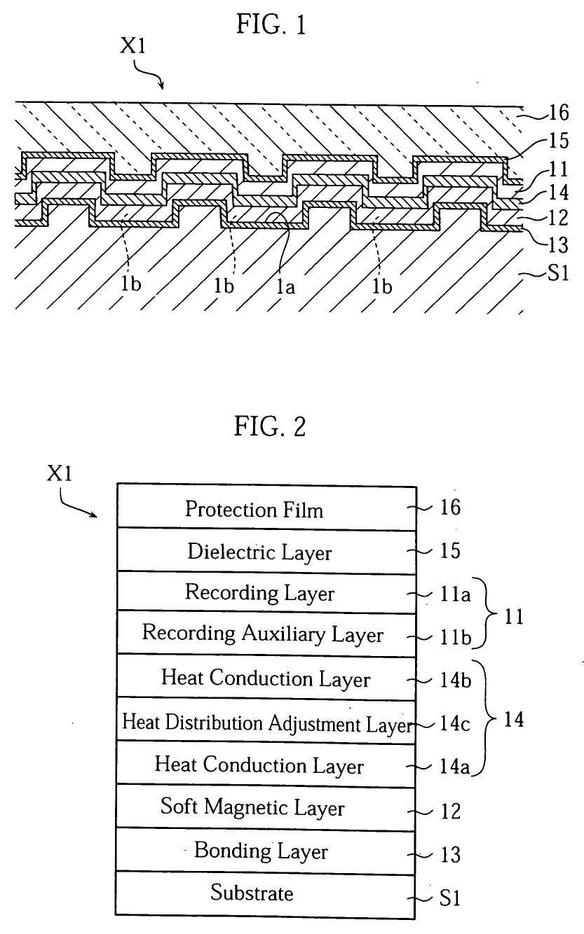

FIG. 1 shows a magneto-optical recording medium X1 according to a first embodiment of the present invention. To be used as a front-illuminated magneto-optical disk, the magneto-optical recording medium X1 comprises a resin substrate S1, a recording magnetic section 11, a soft magnetic layer 12, a bonding layer 13, a heat sink 14, a dielectric layer 15, and a protective film 16.

The resin substrate S1 ensures stiffness of the magneto-optical recording medium X1, and has a pre-groove surface 1a on which pre-grooves 1b of the desired dimensions are formed. This resin substrate S1 is made of, for example, polycarbonate (PC) resin, polymethyl methacrylate (PMMA) resin, epoxy resin, or polyolefin resin.

In the present embodiment, as shown in FIG. 2, the recording magnetic section 11 includes the recording layer 11a and the recording auxiliary layer 11b.

The recording layer 11a supports two functions: thermomagnetic recording and reproduction using magneto-optical effects in the lands and/or grooves used as data tracks. The recording layer is made of an amorphous alloy that includes rare earth elements and transition metals, and is a perpendicularly magnetized film which is magnetized in a vertical direction, exhibiting perpendicular magnetic anisotropy, where the vertical direction means a direction perpendicular to the surface of the magnetized film constituting the layer. Tb, Gd, Dy, Nd, and Pr may be used as the rare earth elements included in the amorphous alloy forming the recording layer 11a, while Fe and Co may be used as the transition metals. More specifically, the recording layer 11a may be made of TbFeCo, DyFeCo, or TbDyFeCo of the prescribed composition. Thickness of the recording layer 11a is, for example, between 25 nm and 65 nm.

The recording auxiliary layer 11b has the function of developing an exchange coupling force between the auxiliary layer and the recording layer 11a to enhance the recording magnetic field sensitivity of the recording layer 11a. The recording auxiliary layer 11b is a perpendicularly magnetized film made of an amorphous alloy of rare earths and transition metals.

In the present invention, the recording magnetic section 11 may comprise only a single recording layer having both recording function and reproduction function, in place of the above-described configuration. The magnetic section may have a two-layer structure that includes a recording layer with a relatively large coercive force for recording function, and a reproduction layer causing a relatively large Kerr rotation in the reproduction laser for reproduction function. The magnetic section may have a three-layer structure that includes a recording layer, a reproduction layer, and an intermediate layer between these two layers, for realizing MSR reproduction, MAMMOS reproduction, or DWDD reproduction.

When a magnetic section is provided with one of the above-described structures, each layer of the selected structure of the magnetic section is made of an amorphous alloy containing a rare earth element and a transition metal, and is a perpendicularly magnetized film exhibiting perpendicular magnetic anisotropy. For the rare earth element, use may be made of Tb, Gd, Dy, Nd, and Pr, for example. For the transition metal, use may be made of Fe and Co, for example. More specifically, the recording layer may be made of TbFeCo, DyFeCo, or TbDyFeCo of the prescribed composition. When a reproduction layer is provided, it may be made of GdFeCo, GdDyFeCo, GdTbDyFeCo, NdDyFeCo, NdGdFeCo, or PrDyFeCo, for example. When an intermediate layer is provided, it may be made of GdFe, TbFe, GdFeCo, GdDyFeCo, GdTbDyFeCo, NdDyFeCo, NdGdFeCo, or PrDyFeCo of the prescribed composition. The thickness of each layer is determined in response to the desired magnetic structure of the magnetic section.

The soft magnetic layer 12 is employed to enhance the recording magnetic field sensitivity of the recording layer 11a included in the recording magnetic section 11, and is a film of soft magnetic material having a high magnetic permeability formed with the electroless deposition method. For example, CoNiFe, FeCo, and FeNi and the like may be employed as this material. Thickness of the soft magnetic layer 12 is, for example, between 200 nm and 1000 nm.

When recording on the magneto-optical recording medium X1, the magnetic flux of the magnetic field applied to the recording layer 11a from the protective film 16 side by the magnetic recording head tends to be concentrated without being dispersed in the recording layer 11a due to the existence of the soft magnetic layer 12 below the recording layer 11a. As a result, the recording magnetic field sensitivity of the recording layer 11a is increased in comparison to the case in which the soft magnetic layer 12 does not exist.

The bonding layer 13 is disposed between the soft magnetic layer 12 formed with the electroless deposition method and the resin substrate S1, for ensuring reliable attachment between these layers. In light of this, the bonding layer is made of a material exhibiting superior attachment with the substrate of synthetic resin (resin substrate S1) and with the soft magnetic, plated film (soft magnetic layer 12). Such a material may be AlCr, Al, Cr, Ti, FeCo, Ni, NiP, Pd, SiN and SiO₂, for example. Thickness of the bonding layer 13 is between 5 nm and 30 nm.

The heat sink 14 is provided for ensuring that heat generated in the recording magnetic section 11 and the like due to laser illumination during recording and reproduction is transmitted to the substrate S1. In the present embodiment, as shown in FIG. 2, the heat sink 14 has a laminated structure including heat conduction layers 14a, 14b and a heat distribution adjustment layer 14c.

The heat conduction layers 14a and 14b are made of high thermal conductivity material. For the high thermal conductivity material, use may be made of Ag, Ag alloy, Al alloy, (AlTi, AlCr, etc.), Au or Pt, for example. The heat distribution adjustment layer 14c has a lower thermal conductivity than the heat conduction layers 14a and 14b, and is made of, for example, SiN. The heat distribution adjustment layer 14c, made of SiN, also functions as a dielectric layer between the substrate S and the magnetic section. Thickness of the heat conduction layers 14a and 14b is, for example, between 20 nm and 50 nm, and thickness of the heat distribution adjustment layer 14c is, for example, between 2 nm and 10 nm.

According to the present invention, the above configuration of the heat sink 14 may be replaced by a configuration consisting of a single heat conduction layer, or by a two-layer configuration consisting of a heat conduction layer and a heat distribution adjustment layer.

The dielectric layer 15 is provided for preventing or reducing external magnetic effects on the recording magnetic section 11, and may be made of, for example, SiN, SiO₂, YSiO₂, ZnSiO₂, AlO, or AlN. Thickness of the dielectric layer 15 is, for example, between 30 nm and 60 nm.

The protective film 16 is made of synthetic resin having sufficient transparency for the recording and reproduction lasers used with the magneto-optical recording medium X1, and has a thickness of between 10 μm and 40 μm. The synthetic resin of the protective film 16 may be, for example, acrylic resin, polycarbonate (PC) resin, epoxy resin, or polyolefin resin.

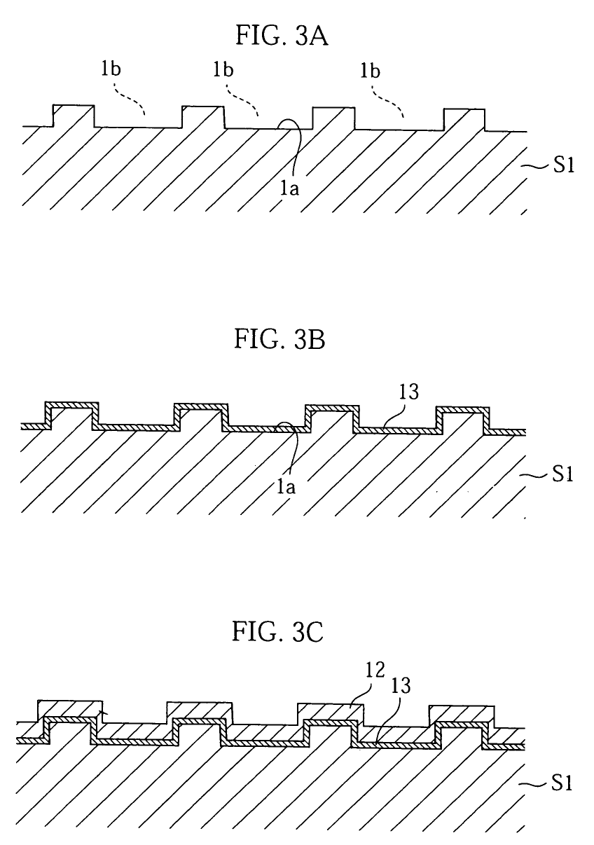

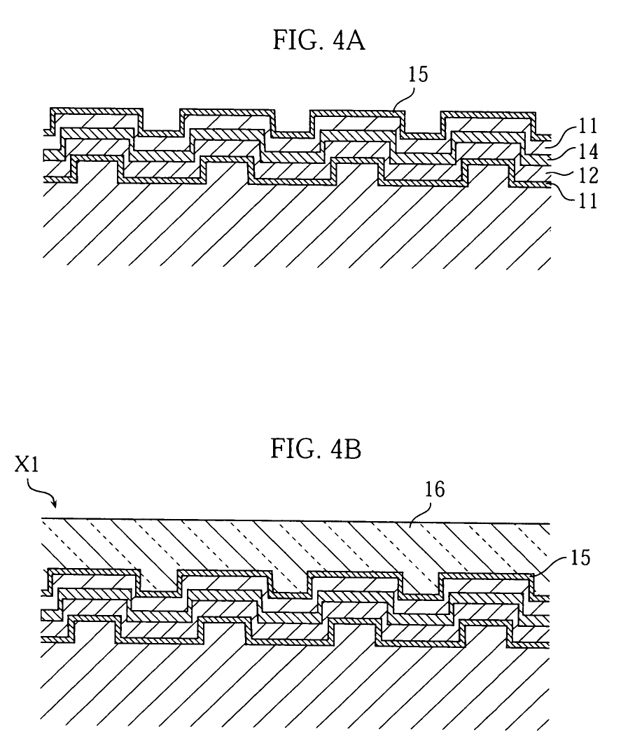

FIGS. 3 and 4 show a method of manufacturing the magneto-optical recording medium X1. In the process of manufacture of the magneto-optical recording medium X1, firstly, as shown in FIG. 3A, a resin substrate S1 is prepared, which has a pre-groove surface 1a formed with pre-grooves 1b. The resin substrate S1 is formed by placing an Ni stamper in a metal mold and injecting synthetic resin into the mold, wherein the stamper is manufactured by a known process of making optical disk blanks. The Ni stamper has an uneven profile for formation of the pre-grooves 1b in the resin substrate S1.

Next, as shown in FIG. 3B, the bonding layer 13 is formed on the pre-groove surface 1a in the resin substrate S1. The bonding layer 13 is made by forming a film of the above-mentioned material used for forming the layer 13 on the pre-groove surface 1a by sputtering, for example.

Next, as shown in FIG. 3C, a soft magnetic layer 12 is formed on the bonding layer 13 with the electroless deposition method. Specifically, a resin substrate S1 formed with the bonding layer 13 is first immersed in an aqueous solution of stannic chloride (between 1 wt % and 5 wt %, at room temperature), and then washed sufficiently. The stannic chloride included in the aqueous solution adheres to the bonding layer 13, and functions as the nuclei for adherence of palladium mentioned below. Next, the resin substrate S1 is immersed in an aqueous solution of palladium chloride (between 0.01 wt % and 0.1 wt %, at room temperature), and then washed sufficiently. The palladium chloride included in the aqueous solution adheres to the surface of the bonding layer 13 with the stannic chloride used as the nuclei, and functions as a catalytic nuclei for formation of the plating mentioned below. Next, the substrate S1 is immersed in a plating bath having the prescribed composition, and a soft magnetic plating layer is formed with the electroless deposition method. The plating bath includes Co, Ni, and Fe and the like in the prescribed concentrations depending on the composition of the soft magnetic layer 12 to be formed. Preferably, the plating bath may include the prescribed concentration of B.

Next, in manufacture of the magneto-optical recording medium X1, as shown in FIG. 4A, the heat sink 14 (heat conduction layer 14a, heat distribution adjustment layer 14c, heat conduction layer 14b), the recording magnetic section 11 (recording auxiliary layer 11b, recording layer 11a), and the dielectric layer 15 are formed in that order on the soft magnetic layer 12. Each layer can be formed with the sputtering method.

Next, as shown in FIG. 4B, the protective film 16 is formed on the dielectric layer 15. When forming the protective film 16, a film of a liquid synthetic resin composition is first formed on the dielectric layer 15. The spin coating method can be employed in forming this film. The synthetic resin composition can be UV-cured and has as its primary constituent the synthetic resin mentioned above for forming the protective film 16. Next, the synthetic resin film is hardened by irradiation of ultraviolet light, whereby the protective film 16 is formed.

Thus, the magneto-optical recording medium X1 shown in FIG. 1 and FIG. 2 is obtained.

With the magneto-optical recording medium X1, the existence of the soft magnetic layer 12 of high magnetic permeability ensures that the magnetic flux of the magnetic field applied to the recording layer 11a from the magnetic recording head during recording tends to be concentrated and not dispersed in the recording layer 12. Therefore, the recording magnetic field sensitivity of the recording layer 11a is enhanced in comparison to the case in which the soft magnetic layer 12 does not exist.

In recording and reproduction processing for the magneto-optical recording medium X1, the recording magnetic section 11 is illuminated by laser from the protective film 16 side. Since the soft magnetic layer 12 is provided on the side opposite to the protective film 16 with respect to the recording magnetic section 11 (recording layer 11a), this front-illuminated recording and reproduction processing is not impeded.

In manufacture of the magneto-optical recording medium X1, after a bonding layer 13 is formed on the resin substrate S1, the soft magnetic layer 12 is laminated on the bonding layer 13 with the electroless deposition method. The bonding layer 13 has superior attachment to the substrate (resin substrate S1) made of synthetic resin material, and superior attachment to the plated film (soft magnetic layer 12) made of soft magnetic material. Since this bonding layer 13 is between the resin substrate S1 and the soft magnetic layer 12, a satisfactory attachment between the resin substrate S1 and the soft magnetic layer 12 can be achieved in the magneto-optical recording medium X1.

In the magneto-optical recording medium X1, the resin substrate S1 itself functions as the pre-groove layer for formation of the land groove shape in the recording magnetic section 11. Thus, there is no need to separately provide a pre-groove layer between the soft magnetic layer 12 and the recording magnetic section 11. The soft magnetic layer 12 and the recording magnetic section 11 are therefore adjacent so that the function of the soft magnetic layer 12 of improving the magnetic field sensitivity of the recording layer within the recording magnetic section can be realized efficiently.

In the magneto-optical recording medium X1, a comparatively inexpensive resin substrate is employed in place of the conventional glass substrate and aluminum substrate. The magneto-optical recording medium X1 is therefore ideal in that it reduces manufacturing costs.

In the magneto-optical recording medium X1, the soft magnetic layer 12 employed to enhance the recording magnetic field sensitivity of the recording layer can be formed with the electroless deposition method able to realize satisfactory throughput in place of the sputtering method employed in the manufacture of conventional mediums. The magneto-optical recording medium X1 is therefore ideal in that it enhances manufacturing efficiency.

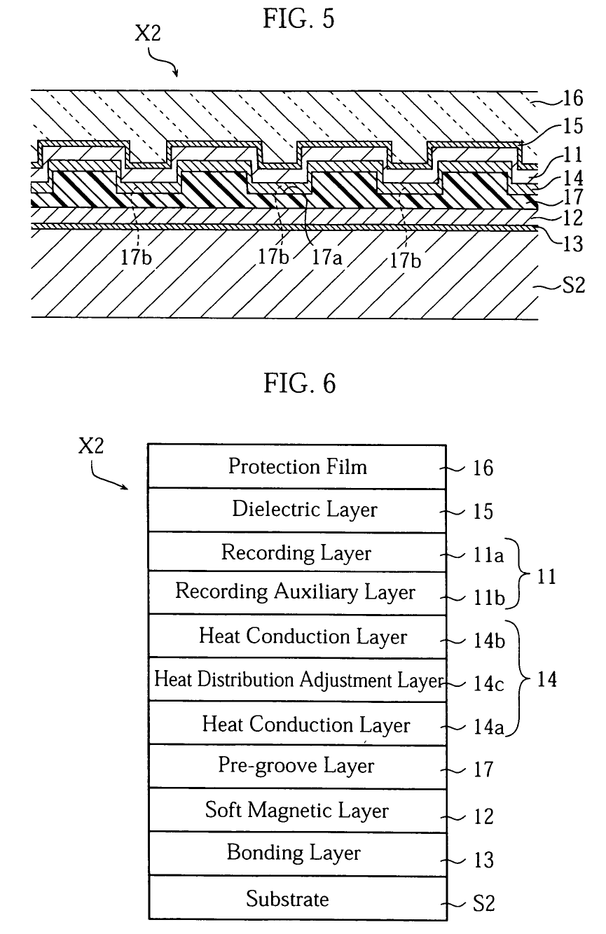

FIG. 5 and FIG. 6 show a magneto-optical recording medium X2 according to a second embodiment of the present invention. The magneto-optical recording medium X2, serving as a front-illuminated magneto-optical disk, comprises a resin substrate S2, a recording magnetic section 11, a soft magnetic layer 12, a bonding layer 13, a heat sink 14, a dielectric layer 15, a protective film 16, and a pre-groove layer 17.

The resin substrate S2 ensures stiffness of the magneto-optical recording medium X2, and is a flat disk substrate. This resin substrate S2 is made of, for example, polycarbonate (PC) resin, polymethyl methacrylate (PMMA) resin, epoxy resin, or polyolefin resin.

The configuration of the recording magnetic section 11, soft magnetic layer 12, bonding layer 13, heat sink 14, dielectric layer 15, and protective film 16 of the magneto-optical recording medium X2 are the same as for the above-described magneto-optical recording medium X1.

The pre-groove layer 17 is made of synthetic resin material, and has a pre-groove surface 17a on which pre-grooves 17b of the desired dimensions are formed. The pre-groove layer 17 is made of, for example, acrylic resin, polycarbonate (PC) resin, epoxy resin, or polyolefin resin.

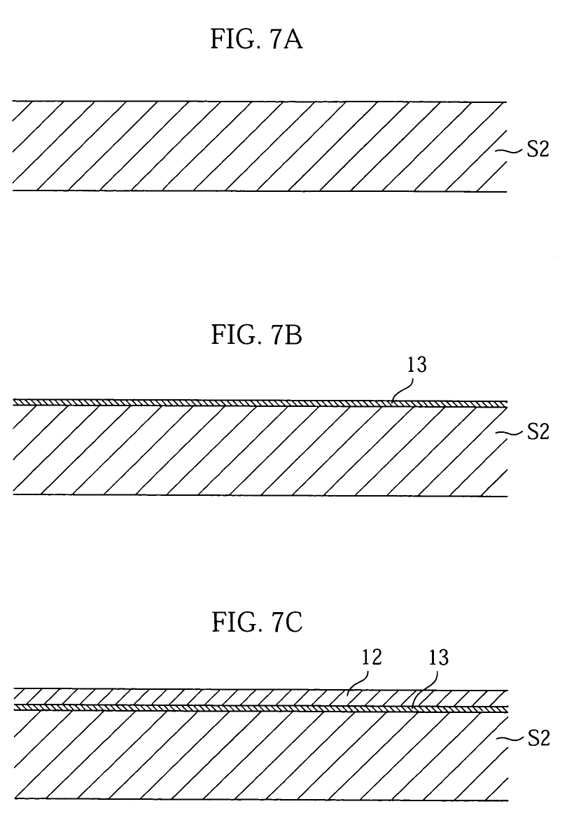

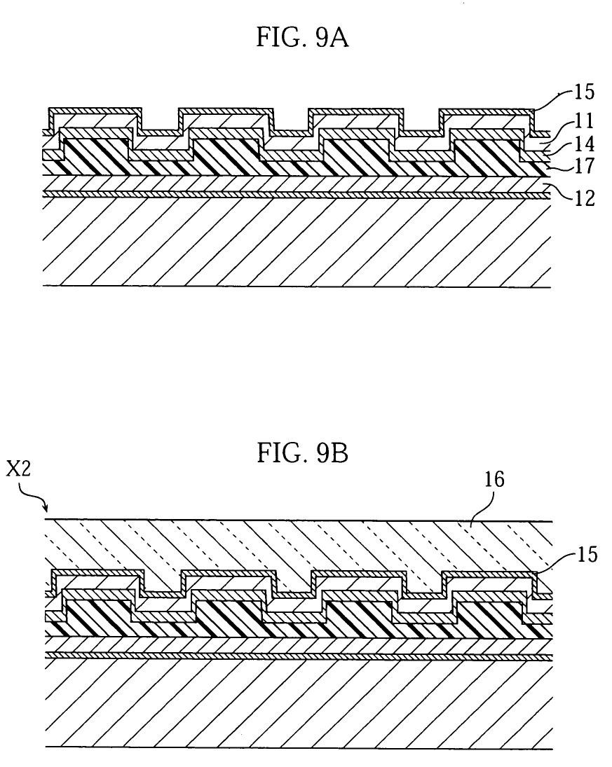

FIG. 7 and FIG. 9 show a method of manufacturing the magneto-optical recording medium X2. In the process of manufacture of the magneto-optical recording medium X2, firstly, as shown in FIG. 7A, a flat resin substrate S2 is prepared. The resin substrate S2 is formed by placing an Ni stamper manufactured with the conventional optical disk blank manufacturing process in a metal mold and injecting synthetic resin into the mold. The Ni stamper is flat in order to ensure a flat surface of the formed resin substrate S2.

Next, the bonding layer 13 is formed on the resin substrate S2 as shown in FIG. 7B. The method of forming the bonding layer 13 is the same as that shown in FIG. 3B in relation to the first embodiment described above.

Next, as shown in FIG. 7C, a soft magnetic layer 12 is formed on the bonding layer 13 with the electroless deposition method. Specific details of the method is the same as those described with reference to FIG. 3C illustrating the first embodiment.

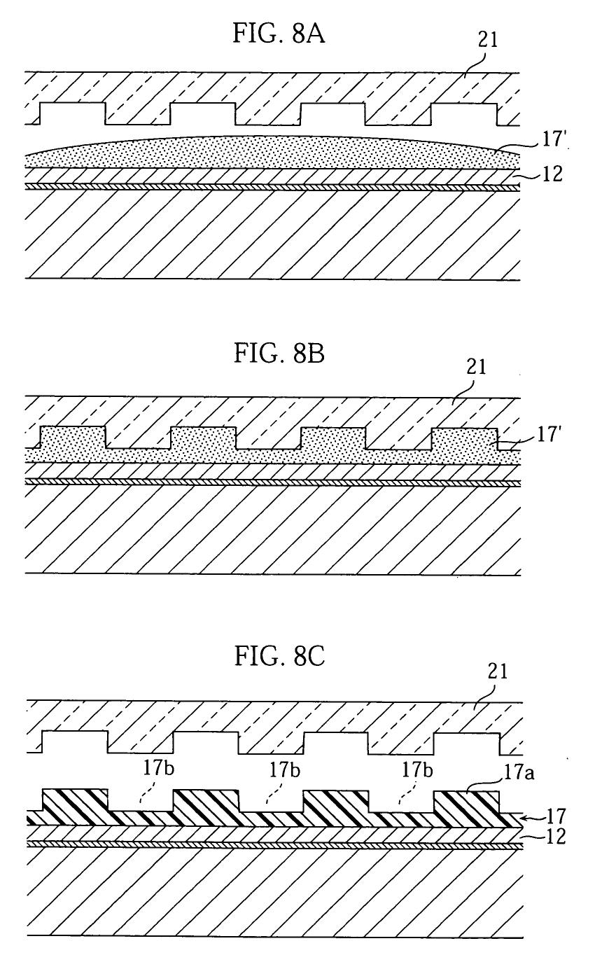

Then, as shown in FIG. 8A and FIG. 8B, the stamper 21 is affixed to the soft magnetic layer 12 via UV cure resin 17′. The stamper 21 is transparent, and has an uneven shape appropriate for the pre-grooves 17b to be formed with the UV cure resin 17′. With the stamper 21 affixed to the soft magnetic layer 12, the UV cure resin 17′ is then illuminated with ultraviolet light from the stamper 21 side. Thus, the synthetic resin is cured, and the pre-groove layer 17 is formed. Next, as shown in FIG. 8C, the stamper 21 is separated from the pre-groove layer 17.

Next, as shown in FIG. 9A, the heat sink 14 (heat conduction layer 14a, heat distribution adjustment layer 14c, heat conduction layer 14b), the recording magnetic section 11 (recording auxiliary layer 11b, recording layer 11a), and the dielectric layer 15 are formed in that order on the pre-groove layer 17. Each layer can be formed with the sputtering method.

Next, as shown in FIG. 9B, the protective film 16 is formed on the pre-groove layer 17. The method of forming the protective film 16 is the same as that shown in FIG. 4B in relation to the first embodiment.

Thus, the magneto-optical recording medium X2 shown in FIG. 5 and FIG. 6 is obtained.

As with the magneto-optical recording medium X1, the recording magnetic field sensitivity of the recording layer 11a in the magneto-optical recording medium X2 is enhanced in comparison to the case in which the soft magnetic layer 12 does not exist.

The magneto-optical recording medium X2 employs front-illumination. Since the soft magnetic layer 12 is provided on the side opposite to the protective film 16 with respect to the recording magnetic section 11 (recording layer 11a), front-illuminated recording and reproduction processing is not impeded.

In manufacture of the magneto-optical recording medium X2, the soft magnetic layer 12 is laminated on the bonding layer 13 with the electroless deposition method following formation of the bonding layer 13 on the resin substrate S2. The bonding layer 13 has superior attachment to the substrate (resin substrate S2) made of synthetic resin material, and superior attachment to the plated film (soft magnetic layer 12) made of soft magnetic material. Since this bonding layer 13 is between the resin substrate S2 and the soft magnetic layer 12, a satisfactory attachment between the resin substrate S2 and the soft magnetic layer 12 can be achieved in the magneto-optical recording medium X2.

In the magneto-optical recording medium X2, the recording layer 11a is adjacent to the pre-groove layer 17, to which the uneven shape of the pre-groove forming stamper is transferred directly. Such a configuration is ideal in that it realizes the land groove shape with high dimensional accuracy in the recording magnetic section 11.

In the magneto-optical recording medium X2, since a comparatively inexpensive resin substrate is employed, the magneto-optical recording medium X2 is ideal for reducing manufacturing costs.

In the magneto-optical recording medium X2, since the soft magnetic layer 12, employed to enhance the recording magnetic field sensitivity of the recording layer 11a, is formed with the electroless plating method, which is capable of realizing satisfactory throughput. Thus, the magneto-optical recording medium X2 is ideal for enhancing the manufacturing efficiency.

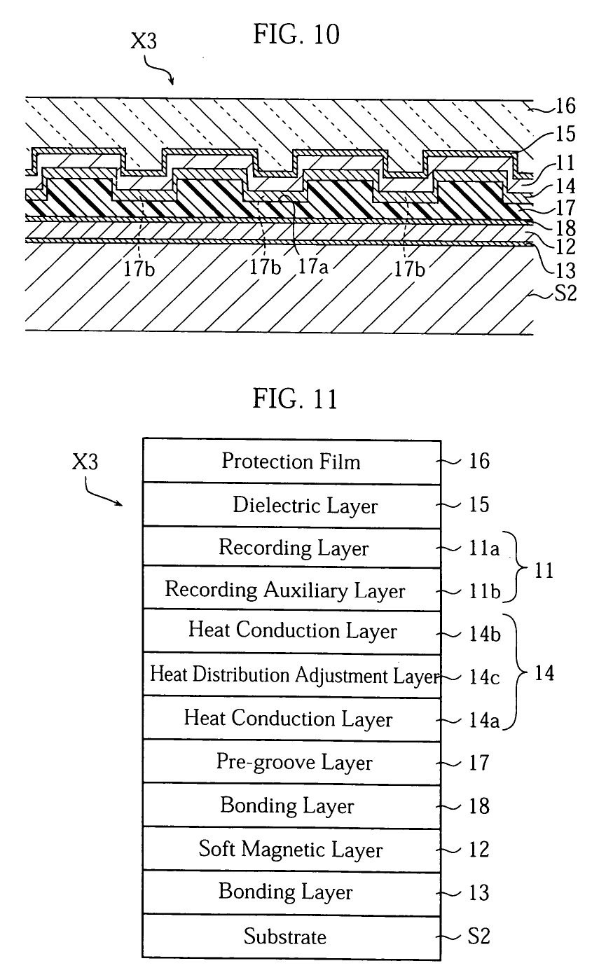

FIG. 10 and FIG. 11 show the magneto-optical recording medium X3 according to the third embodiment of the present invention. The magneto-optical recording medium X3, serving as a front-illuminated magneto-optical disk, comprises a resin substrate S2, a recording magnetic section 11, a soft magnetic layer 12, bonding layers 13 and 18, a heat sink 14, a dielectric layer 15, a protective film 16, and a pre-groove layer 17. Apart from the inclusion of the bonding layer 18 between the soft magnetic layer 12 and the pre-groove layer 17, the magneto-optical recording medium X3 has the same configuration as the magneto-optical recording medium X2.

The bonding layer 18 is interposed between the soft magnetic layer 12 formed with the electroless deposition method and the pre-groove layer 17 to increase attachment between these layers. The bonding layer 18 provides superior attachment with the synthetic resin pre-groove layer 17, and is made of a material having superior attachment with the soft magnetic layer 12 formed with the electroless deposition method. For example, AlCr, Al, Cr, Ti, FeCo, Ni, NiP, Pd, SiN, and SiO₂ and the like may be employed as this material. Thickness of the bonding layer 18 is, for example, between 5 nm and 30 nm.

Apart from its formation after the soft magnetic layer 12, and the conducting the process of forming the bonding layer 18 on the soft magnetic layer 12 again prior to formation of the pre-groove layer 17, the magneto-optical recording medium X3 having this structure is manufactured with the same process as the magneto-optical recording medium X2. The sputtering method is employed in forming the bonding layer 18.

The magneto-optical recording medium X3 can enjoy the same advantages as those described above with the magneto-optical recording medium X2.

Furthermore, since the bonding layer 18 having superior attachment with the soft magnetic layer 12, and superior attachment with the pre-groove layer 17 made of synthetic resin material, is interposed between the soft magnetic layer 12 and the pre-groove layer 17, a satisfactory attachment between the soft magnetic layer 12 the pre-groove layer 17 can be achieved in the magneto-optical recording medium X3.

### EXAMPLE 1

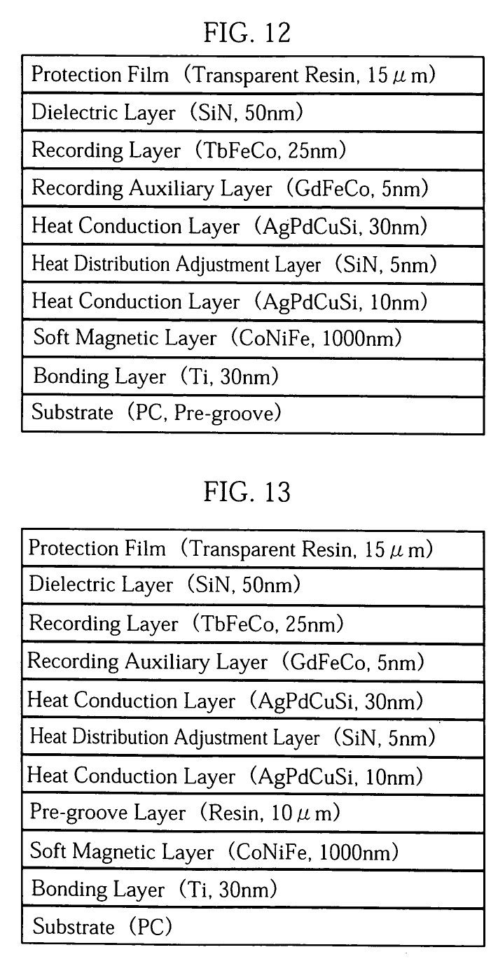

A magneto-optical recording medium of the present example was manufactured as a front-illuminated magneto-optical disk having the laminated configuration as shown in FIG. 12.

In manufacture of the magneto-optical recording medium of the present example, firstly, spiral-shaped pre-grooves were manufactured in the surface of a polycarbonate substrate (diameter: 86 mm, thickness: 1.2 mm, land width: 0.275 μm, groove width: 0.275 μm, groove depth: 50 nm). Specifically, an Ni stamper having a spiral pattern on its surface of 50 nm in depth and 0.275 μm track pitch was placed in a metal mold, and the substrate is formed by injecting synthetic resin into the mold.

Next, a bonding layer of 30 nm in thickness was formed by using a DC magnetron sputtering apparatus to form a Ti film on the pre-groove surface of the substrate with the DC sputtering method. This sputtering employed a Ti target and Ar gas as the sputter gas, with a sputter gas pressure of 0.5 Pa, and discharge power of 400 W.

Next, a soft magnetic layer of 1000 nm in thickness was formed on the bonding layer using the electroless deposition method. Specifically, the substrate on which the bonding layer had been formed as described above was first immersed for a period of one minute in a 3 wt % aqueous solution of stannic chloride at 35° C., and was washed with pure water. Next, the substrate was immersed for a period of one minute in a 0.05 wt % aqueous solution of palladium chloride at 35° C., and was washed with pure water. Next, the substrate was immersed in an electroless deposition bath at 55° C. for the prescribed period, and was washed with pure water. This electroless deposition bath contained an aqueous solution of 0.1 wt % dimethylamine borane, 0.3 wt % nickel sulfate, 0.3 wt % ferrous sulfate, and 3 wt % cobalt sulfate. Thus, a soft magnetic layer (CoNiFe) of 1000 nm in thickness was formed with the electroless deposition method.

Next, a film of AgPdCuSi alloy was formed on the soft magnetic layer using the DC sputtering method, thus forming a first heat conduction layer of 10 nm in thickness. Specifically, co-sputtering using an AgPdCu alloy target and an Si target was employed, with Ar gas as the sputter gas, a sputter gas pressure of 0.5 Pa. Discharge power for the AgPdCu alloy target was 500 W, and 40 W for the Si target.

Next, a heat distribution adjustment layer of 5 nm in thickness was formed by forming a film of SiN on the first thermally conducting using the DC sputtering method. Specifically, a film of SiN was formed on the substrate by reactive sputtering using an Si target, and Ar and N₂ gases as sputter gases. The flow ratio of Ar and N₂ gases employed in this sputtering was 3:1, sputter gas pressure was 1.5 Pa, and discharge power was 800 W.

Next, a second heat conduction layer of 30 nm in thickness was formed by forming a film of AgPdCuSi on the heat distribution adjustment layer using the DC sputtering method. Specifically, sputtering conditions were the same as described above for the first heat conduction layer. Thus, a heat sink including a first heat conduction layer (AgPdCuSi, thickness 10 nm), a heat distribution adjustment layer (SiN, thickness 5 nm), and a second heat conduction layer (AgPdCuSi, thickness 30 nm), was formed.

In manufacture of the magneto-optical recording medium of the example, a recording auxiliary layer of 5 nm in thickness was next formed by forming a film of GdFeCo amorphous alloy (Gd₂₅Fe₄₉Co₂₆) on the second heat conduction layer using the DC sputtering method. A GdFeCo alloy target was employed in this sputtering, Ar gas was employed as the sputter gas, sputter gas pressure was 0.5 Pa, and sputter power was 500 W.

Next, a recording layer of 25 nm in thickness was formed by forming a film of TbFeCo amorphous alloy (Tb₂₃Fe₆₁Co₁₆) on the recording auxiliary layer using the DC sputtering method. A TbFeCo alloy target was employed in this sputtering, Ar gas was employed as the sputter gas, sputter gas pressure was 1.5 Pa, and discharge power was 500 W. Thus, a recording magnetic section having a recording function and a reproduction function were formed from a recording layer (Tb₂₃Fe₆₁Co₁₆, thickness 25 nm) and a recording auxiliary layer (Gd₂₅Fe₄₉Co₂₆, thickness 5 nm) Next, a dielectric layer of 50 nm in thickness was formed by forming a film of SiN on the recording layer. Specifically, a film of SiN was formed on the substrate by reactive sputtering using an Si target, and Ar and N₂ gases as sputter gases. The flow ratio of Ar and N₂ gases employed in this sputtering was 3:1, sputter gas pressure was 1.5 Pa, and discharge power was 800 W.

Next, a transparent protective film of 15 μm was formed on the dielectric layer. Specifically, a film of UV cure resin (Daicure Clear, manufactured by Dai Nippon Ink and Chemicals Incorporated) and 15 μm in thickness was formed on the dielectric layer using the spin coating method. Next, the UV cure resin is cured by exposure to ultraviolet light to form a protective film on the dielectric layer. Thus, the magneto-optical recording medium of the present example was manufactured.

The dependence of the bit error rate (BER) for the reproduction signal on the recording magnetic field was investigated for the magneto-optical recording medium of the above example. Specifically, a random signal having a minimum mark length of 0.15 μm was first recorded on the data tracks (groove track and land track) on the magneto-optical recording medium. The recording processing was conducted using the prescribed optical disk evaluation apparatus with magnetic field modulation recording. The numerical aperture NA of the objective lens in this evaluation apparatus was 0.85, and the laser wavelength was 405 nm. For the recording processing, laser scan speed was set to 7.5 m/s, and each data track was illuminated with a continuous laser pulse (18 mW laser power) while the prescribed applied magnetic field was modulated.

Next, only the groove track, or only the land track, on the magneto-optical recording medium was reproduced, and the modulation signal during recording, and the demodulation signal during reproduction, compared and the reproduction demodulation signal error rate for the recording modulation signal calculated as the bit rate error (BER). The same evaluation apparatus was employed for the reproduction processing, laser power was set to 18 mW, and laser scan speed was set to 7.5 m/s.

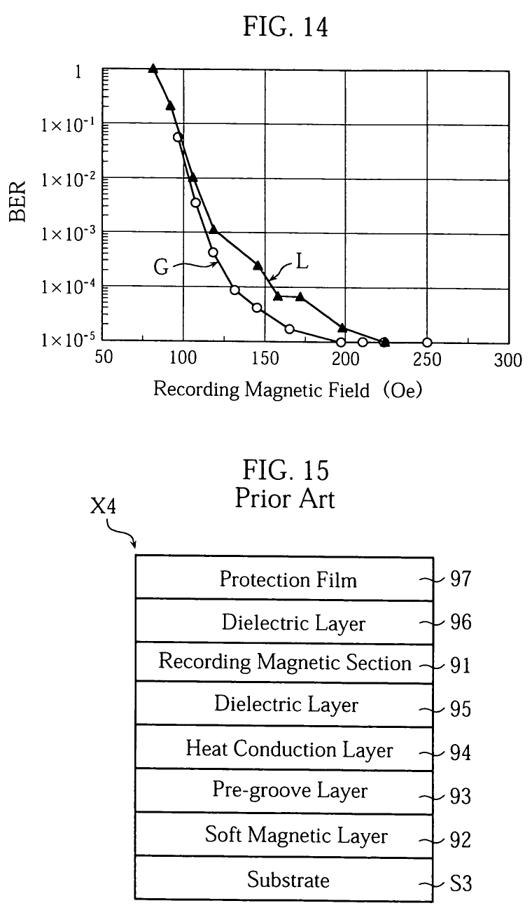

The recording processing and subsequent reproduction processing was conducted for each recording magnetic field by changing the magnetic field (recording magnetic field) applied during recording processing, and the BER for each recording magnetic field measured. Dependence of the BER on recording magnetic field for each magneto-optical recording medium is shown in the graph in FIG. 14. In the graph in FIG. 14, the recording magnetic field (Oe) generated by the magnetic recording head is shown on the horizontal axis, and the BER is shown in the vertical axis. The line G shows the dependence of the BER on the recording magnetic field for the groove track, and the line L shows the dependence of the BER on the recording magnetic field for the land track.

According to the graph in FIG. 14, it is apparent that a comparatively high recording magnetic field sensitivity is achieved in the magneto-optical recording medium of the above example. Furthermore, it is apparent that the recording magnetic field sensitivity of the recording layer of the groove track is greater than that of the land track.

### COMPARATIVE EXAMPLE 1

A magneto-optical recording medium having the same laminated configuration as the magneto-optical recording medium of Example 1, except for a soft magnetic layer provided directly on the resin substrate without the Ti bonding layer between the resin substrate and the soft magnetic layer, was experimentally manufactured.

Firstly, as with Example 1, spiral-shaped pre-grooves were manufactured in the surface of a polycarbonate substrate (diameter: 86 mm, thickness: 1.2 mm, land width: 0.275 μm, groove width: 0.275 μm, groove depth: 50 nm).

Next, a soft magnetic layer was formed on the pre-groove surface of the substrate using the electroless deposition method in the same manner as for Example 1, however a soft magnetic plating layer with good reproducibility could not be formed. Even when a soft magnetic plating layer was able to be formed, the material film peeled from the substrate surface in subsequent processes. A magneto-optical recording medium could therefore not be manufactured.

### EXAMPLE 2

A magneto-optical recording medium of the present example was manufactured as a front-illuminated magneto-optical disk having the laminated configuration as shown in FIG. 13.

In manufacture of the magneto-optical recording medium of the present example, firstly, a flat polycarbonate substrate (diameter: 86 mm, thickness: 1.2 mm) was manufactured for application of a bonding layer. Specifically, a flat Ni stamper without pre-grooves was placed in a metal mold, and the substrate formed by injecting synthetic resin into the mold.

Next, a bonding layer (Ti, thickness: 30 nm) and a soft magnetic layer (CoNiFe, thickness: 1000 nm) were formed on the flat surface of the substrate in the same manner as with Example 1.

Next, UV cure resin (Yupima, manufactured by Mitsubishi Chemical Corporation) was applied to the soft magnetic layer, and a stamper transparent to the synthetic resin affixed to the soft magnetic layer. This transparent stamper has a spiral pattern having a depth of 50 nm, and a track pitch of 0.275 μm, on the contact surface with the synthetic resin. The synthetic resin was cured by exposure to ultraviolet light, and the stamper then peeled from the synthetic resin. Thus, the spiral pattern of the stamper was transferred, forming spiral pre-grooves in the pre-groove layer (thickness: 10 μm, land width: 0.275 μm, groove width: 0.275 μm, groove depth: 50 nm) on the surface.

In manufacture of the present magneto-optical recording medium, a first heat conduction layer (AgPdCuSi, thickness 10 nm), a heat distribution adjustment layer (SiN, thickness 5 nm), a second heat conduction layer (AgPdCuSi, thickness 30 nm), a recording auxiliary layer (GdFeCo, thickness: 5 nm), a recording layer (TbFeCo, thickness: 25 nm), a dielectric layer (SiN, thickness: 50 nm), and a protective layer (UV cure resin, thickness: 15 μm) were formed in that order on the pre-groove layer in the same manner as with Example 1. The magneto-optical recording medium of the present example was thus manufactured as described above.

When dependence of the BER on the recording magnetic field was investigated for the magneto-optical recording medium of the above example in the same manner as with Example 1, similar characteristics were obtained to the magneto-optical recording medium of Example 1.

1. A magneto-optical recording medium, comprising:
a resin substrate including a pre-groove surface formed with pre-grooves;
a recording magnetic section performing a recording function and a reproduction function;
a soft magnetic plating layer provided between the resin substrate and the recording magnetic section; and
a bonding layer interposed between the resin substrate and the soft magnetic plating layer for enhancing attachment of the substrate and the soft magnetic plating layer.

2. The magneto-optical recording medium according to claim 1, wherein the bonding layer comprises a material selected from the group of AlCr, Al, Cr, Ti, FeCo, Ni, NiP, Pd, SiN, and SiO₂.

3. The magneto-optical recording medium according to claim 1, wherein the bonding layer has a thickness of between 5 nm and 30 nm.

4. The magneto-optical recording medium according to claim 1, wherein the soft magnetic plating layer is made of CoNiFe.

5. A magneto-optical recording medium, comprising:
a resin substrate;
a recording magnetic section performing a recording function and a reproduction function;
a soft magnetic plating layer provided between the resin substrate and the recording magnetic section;
a pre-groove layer provided between the soft magnetic plating layer and the recording magnetic section; and
a bonding layer interposed between the resin substrate and the soft magnetic plating layer for enhancing attachment of the substrate and the soft magnetic plating layer.

6. The magneto-optical recording medium according to claim 5, wherein the bonding layer comprises a material selected from the group of AlCr, Al, Cr, Ti, FeCo, Ni, NiP, Pd, SiN, and SiO₂.

7. The magneto-optical recording medium according to claim 5, wherein the bonding layer has a thickness of between 5 nm and 30 nm.

8. The magneto-optical recording medium according to claim 5, wherein the soft magnetic plating layer is made of CoNiFe.

9. The magneto-optical recording medium according to claim 5, wherein the pre-groove layer is made of a resin material, and wherein a bonding layer is interposed between the soft magnetic plating layer and the pre-groove layer for enhancing attachment of the soft magnetic plating layer and the pre-groove layer.

10. A method for manufacturing a magneto-optical recording medium, comprising the steps of:
forming a bonding layer on a pre-groove surface of a resin substrate by formation of a film of a material selected from the group of AlCr, Al, Cr, Ti, FeCo, Ni, NiP, Pd, SiN, and SiO₂ using a sputtering method, the pre-groove surface being formed with pre-grooves;
forming a soft magnetic plating layer on the bonding layer by formation of a film of soft magnetic material using an electroless deposition method; and
forming a recording magnetic section performing a recording function and a reproduction function.

11. A method for manufacturing a magneto-optical recording medium, comprising the steps of:
forming a bonding layer on a resin substrate by formation of a film of a material selected from the group of AlCr, Al, Cr, Ti, FeCo, Ni, NiP, Pd, SiN, and SiO₂ using a sputtering method;
forming a soft magnetic plating layer on the bonding layer by formation of a film of soft magnetic material using an electroless deposition method;
forming a pre-groove layer on the soft magnetic plating layer; and
forming a recording magnetic section performing a recording function and a reproduction function.

12. A method for manufacturing a magneto-optical recording medium, comprising the steps of:
forming a first bonding layer on a resin substrate by formation of a film of a material selected from the group of AlCr, Al, Cr, Ti, FeCo, Ni, NiP, Pd, SiN, and SiO₂ using a sputtering method;
forming a soft magnetic plating layer on the bonding layer by formation of a film of soft magnetic material using an electroless deposition method;
forming a second bonding layer on the soft magnetic plating layer by formation of a film of a material selected from the group of AlCr, Al, Cr, Ti, FeCo, Ni, NiP, Pd, SiN, and SiO₂ using a sputtering method;
forming a pre-groove layer of a resin material on the second bonding layer; and
forming a recording magnetic section performing a recording function and a reproduction function.
